(19) United States
(12) Patent Application Publication
(10) Pub. No.: US 2014/0003777 A1
(43) Pub. Date: Jan. 2, 2014

(54) LIGHT FOCUSING STRUCTURES FOR FIBER OPTIC COMMUNICATIONS SYSTEMS AND METHODS OF FABRICATING THE SAME USING SEMICONDUCTOR PROCESSING AND MICRO-MACHINING TECHNIQUES

(71) Applicant: Abhijit Sengupta, Alpharetta, GA (US)

(72) Inventor: Abhijit Sengupta, Alpharetta, GA (US)

(73) Assignee: CommScope, Inc. of North Carolina, Hickory, NC (US)

(21) Appl. No.: 13/597,356

(22) Filed: Aug. 29, 2012

Related U.S. Application Data
(60) Provisional application No. 61/667,008, filed on Jul. 2, 2012.

(51) Int. Cl. G02B 6/028; B26D 7/08; B05D 5/06; G02B 3/08; B44C 1/22

(52) U.S. Cl. 385/124; 359/742; 216/24; 427/508; 427/162; 83/14

(57) ABSTRACT

Methods of fabricating light focusing elements for use in a fiber optic communications system are disclosed in which a plurality of light focusing elements are formed on or in a top surface of a substrate. The substrate is then diced to singulate the light focusing elements.

### CROSS-REFERENCE TO RELATED APPLICATION

The present application claims priority under 35 U.S.C. §119(e) from U.S. Provisional Patent Application Ser. No. 61/667,008, filed Jul. 2, 2012, the entire content of which is incorporated herein by reference as if set forth in its entirety.

### BACKGROUND

The present disclosure relates generally to fiber optic communications systems and, more particularly, to methods of mass-producing light focusing structures for such systems using semiconductor processing and micro-machining techniques.

There are various applications in fiber optic communications systems in which it may be desirable to focus a relatively large area light field into a smaller area light field, or vice versa. As one example, in some applications, it may be desirable to focus an optical signal that is transmitted over a single-mode optical fiber onto a smaller diameter (or other shaped) waveguide structure for purposes of, for example, coupling the optical signal onto an integrated circuit chip. As another example, it may be desirable to focus a larger area light field that is output by an optical source onto a smaller area optical transmission path such as an optical fiber or an optical waveguide.

### SUMMARY

Pursuant to embodiments of the present invention, methods of fabricating light focusing elements for use in fiber optic communications system are provided. Pursuant to these methods, a plurality of light focusing elements are formed on a substrate. The substrate is then diced to singulate the light focusing elements for use in a fiber optic communications system.

In some embodiments, the light focusing elements may be graded index structures such as, for example, graded index waveguides In other embodiments, the light focusing elements may be Fresnel lens. The light focusing elements may be formed using, for example, photolithography processes to etch a top surface of the substrate or one or more layers that are deposited on the top surface of the substrate. In other embodiments, the light focusing elements may be formed via laser micro-machining.

Pursuant to further embodiments of the present invention, wafers are provided that include a substrate that has a plurality of light focusing elements on an upper surface thereof. A plurality of scribe lines are provided on the wafer that separate the light focusing elements into rows and columns. Each light focusing element on the wafer may be configured to focus a large area light field that is incident in a direction that is generally normal to the top surface of the substrate into a smaller area light field.

Pursuant to still further embodiments of the present invention, methods of fabricating light focusing elements for use in a fiber optic communications system are provided in which a plurality of diffractive patterns are formed on a substrate via at least one of lithography, dry etching, wet etching, laser micromachining or nano-machining to form a plurality of light focusing elements on the substrate. The substrate is then diced to singulate the light focusing elements.

### BRIEF DESCRIPTION OF THE DRAWINGS

FIG. 1A is schematic side view of a light focusing element according to embodiments of the present invention.

FIG. 1B is a schematic plan view of the light focusing element of FIG. 1A.

FIG. 1C is a cross-sectional view taken along the line 1C-1C of FIG. 1B.

FIG. 1D is a schematic plan view of a substrate that includes a plurality of the light focusing structures of FIGS. 1A-1C.

FIG. 1E is a schematic side view of a modified version of the light focusing element of FIGS. 1A-1C that includes a reflective layer so that the light focusing element may operate in a reflective mode.

FIG. 1F is a schematic plan view of a light focusing element according to further embodiments of the present invention.

FIG. 1G is a cross-sectional view taken along the line 1G-1G of FIG. 1F.

FIGS. 2A-2C are cross-sectional diagrams that illustrate processes according to embodiments of the present invention that may be used to fabricate the substrate of FIG. 1D.

FIG. 3A is a schematic plan view of a light focusing element according to further embodiments of the present invention.

FIG. 3B is a cross-sectional view taken along the line 3B-3B of FIG. 3A.

FIG. 3C is a graph that illustrates the refractive index of the various layers of the graded index structures included in the light focusing element of FIGS. 3A-3B.

FIG. 3D is a schematic plan view of a substrate that includes a plurality of the light focusing structures of FIGS. 3A-3B.

FIGS. 4A and 4C are schematic plan views, and FIGS. 4B and 4D are cross-sectional views taken along the lines 4B-4B and 4D-4D of FIGS. 4A and 4C, respectively, that together illustrate an example method of fabricating the light focusing element of FIGS. 3A-3B.

FIG. 5A is schematic end view of alight focusing element according to yet further embodiments of the present invention.

FIG. 5B is a schematic plan view of the light focusing element of FIG. 5A.

FIG. 5C is a schematic side view of the light focusing element of FIG. 5A.

FIG. 5D is a graph that illustrates the refractive index of the various layers of the graded index waveguide included in the light focusing element of FIGS. 5A-5C.

FIG. 6A is schematic end view of a light focusing element according to additional embodiments of the present invention.

FIG. 6B is a schematic plan view of the light focusing element of FIG. 6A.

FIG. 6C is a schematic side view of the light focusing element of FIG. 6A.

FIG. 7A is a plan view of a light focusing element according to still further embodiments of the present invention.

FIG. 7B is a cross-sectional view of the light focusing element of FIG. 7A taken along line 7B-7B of FIG. 7A.

FIG. 8A is a schematic plan view of a light focusing element according to yet another embodiment of the present invention.

FIG. 8B is a cross-sectional view of the light focusing element of FIG. 8A taken along line 8B-8B of FIG. 8A.

FIG. 8C is a schematic diagram illustrating how the light focusing element of FIGS. 8A-8B may be used to couple optical signals from a first multi-core optical fiber to a second multi-core optical fiber.

FIG. 8D is a schematic diagram illustrating how the light focusing element of FIGS. 8A-8B may be used to couple optical signals from a plurality of waveguides onto a multi-core optical fiber.

FIG. 8E is a schematic diagram illustrating how the light focusing element of FIGS. 8A-8B may be used to couple the outputs of multiple optical sources onto a multi-mode optical fiber.

### DETAILED DESCRIPTION

Pursuant to embodiments of the present invention, methods of using semiconductor processing and/or micro-machining techniques to mass-produce light focusing elements for fiber optic communications systems are disclosed. Pursuant to some of these methods, semiconductor growth and patterning processes may be used to grow hundreds, thousands or even tens of thousands of light focusing elements on a single substrate. The substrate may then be singulated into individual light focusing elements using standard semiconductor scribing/dicing techniques. Pursuant to other embodiments, semiconductor patterning techniques may be used to pattern a substrate in a manner that forms hundreds, thousands or even tens of thousands of light focusing elements on the substrate. In still further embodiments, laser micro-machining techniques, two-photon polymerization techniques and/or other material modification techniques may be used to mass-produce large numbers of light focusing elements on a substrate, which may then be singulated into individual light focusing elements. In some embodiments, the light focusing elements may be configured to focus a light field that is received in a plane that is generally perpendicular to the substrate on which the light focusing elements are formed such that the light field travels through the substrate from a top surface to a bottom surface thereof.

A wide variety of light focusing elements may be formed using the techniques according to embodiments of the present invention including, for example, Fresnel lenses, other refractive light focusing structures, graded index structures, graded index waveguides, other photonic waveguides and the like. Embodiments of the present invention will now be discussed in detail with reference to the attached drawings, in which certain embodiments of the invention are shown

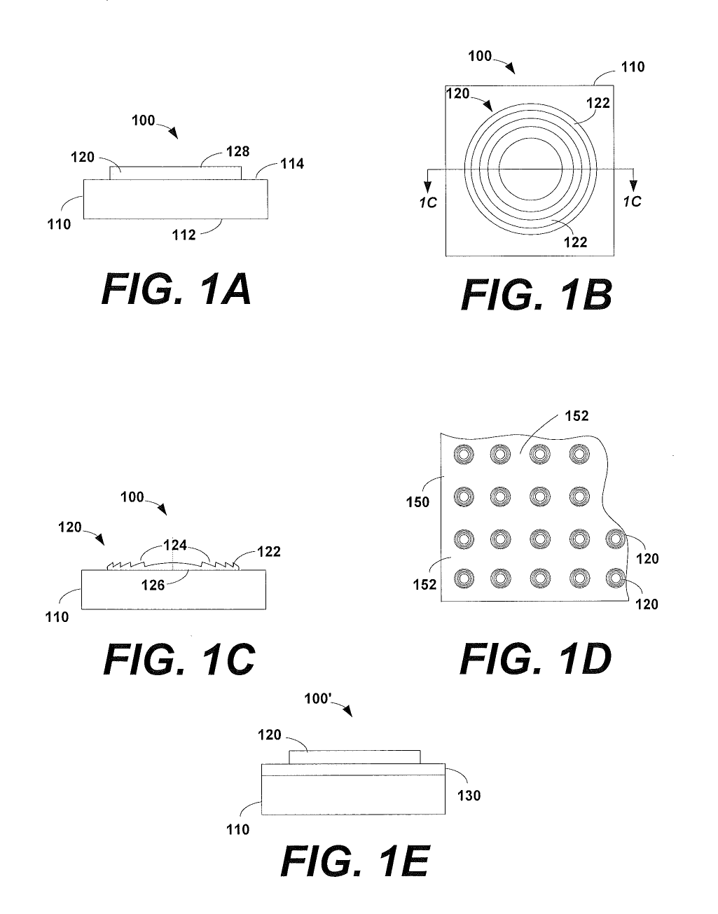

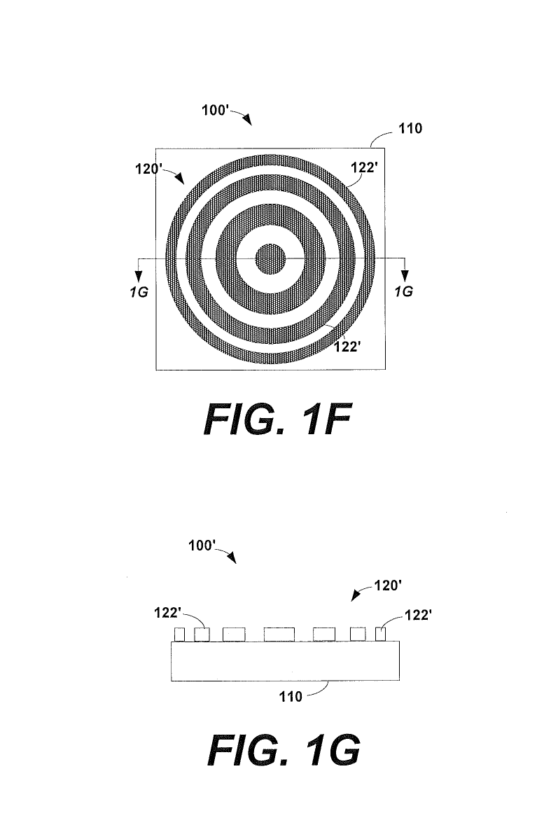

FIGS. 1A-1C illustrate a light focusing element 100 according to certain embodiments of the present invention. In particular, FIG. 1A is schematic side view of the light focusing element 100, FIG. 1B is a schematic plan view of the light focusing element 100, and FIG. 1C is a cross-sectional view of the light focusing element 100 taken along the line 1C-1C of FIG. 1B.

Referring to FIGS. 1A-1C, the light focusing element 100 includes a substrate 110 that has a bottom surface 112 and a top surface 114. A light focusing structure in the form of Fresnel lenses 120 is disposed on the top surface 114 of the substrate 110. The substrate 110 may comprise, for example, a semiconductor substrate such as a silicon substrate, a silicon carbide substrate, etc. or a non-semiconductor substrate such as, for example, a sapphire substrate, a silica substrate, etc., or a combination of both semiconductor and non-semiconductor substrates such as a silicon-on-insulator substrate. The substrate 110 may be transparent at a particular wavelength or range of wavelengths (i.e., for the range of wavelengths for optical signals that are to be focused by the Fresnel lens 120). For example, in some embodiments, the substrate 110 may be transparent for at least a range of wavelengths from about 830 nm to about 1360 nm. Herein, a “transparent” substrate refers to a substrate that passes at least about 90% of light that is incident thereon. As discussed below, in other embodiments (e.g., embodiments in which the Fresnel lens 120 operates in a reflective mode) the substrate 110 need not be transparent at a range of wavelengths of interest and may, instead, be reflective at the range of wavelengths of interest.

As is best shown in FIGS. 1B and 1C, each Fresnel lens 120 includes a plurality of concentric annular sections 122 that are sometimes referred to as “Fresnel zones.” Each Fresnel zone 122 may have an angled outer surface 124, and stepwise discontinuities may be provided between adjacent Fresnel zones 122 (see FIG. 1C). The angle of the outer surface 124 of each Fresnel zone 122 may be different in order to focus light that is incident on the Fresnel lens 120 to a smaller area light field. The Fresnel lens 120 has a lower surface 126 that may be directly on the upper surface 114 of the substrate 110, and an upper surface 128 which comprises the outer surfaces 124 of the Fresnel zones 122. A central portion of the Fresnel lens 120 may have the shape of a standard lens. As shown in FIG. 1B, the Fresnel zones 122 may become increasingly thinner the further they are from the center of the Fresnel lens 120. In some embodiments, all of the Fresnel zones 122 may be formed integrally from a single piece of material. In other embodiments, the Fresnel zones 122 may be formed from different materials. In some embodiments, the substrate 110 and the Fresnel lens 120 may comprise different materials. In other embodiments, the substrate 110 and the Fresnel lens 120 may be formed of the same material. In some of these embodiments, the Fresnel lens 120 may be formed by patterning the substrate 110 by, for example, photolithography or micro-machining processes, to form the Fresnel lens 120 in or on the upper surface 114 of the substrate 110.

Light such as an optical signal that is incident on the upper surface 128 of the Fresnel lens 120 passes through the Fresnel lens 120 and is focused into a smaller area light field. In some embodiments, the substrate 110 may be removed after the Fresnel lens 120 is fabricated using, for example, a grinding process, a chemical-mechanical polishing process and/or an etching process. In other embodiments, the substrate 110 may be left in place.

FIG. 1D is a schematic plan view of a portion of a substrate 150 that includes a plurality of Fresnel lens 120 that are disposed thereon. The substrate 150 may be identical to the substrate 110 that is described above, except that the substrate 150 may be much larger so that a plurality of Fresnel lens 120 may be fabricated thereon. The substrate 150 may include scribe lines 152 that run in rows and columns between the Fresnel lens 120. After the Fresnel lens 120 are formed in or on the substrate 150, the substrate 150 may be singulated by dicing the substrate 150 along the scribe lines 152 to create a plurality of the individual light focusing elements 100 of FIGS. 1A-1C. While FIG. 1D depicts a total of eighteen Fresnel lenses 120 on the portion of the substrate that is illustrated, it will be appreciated that very large numbers of Fresnel lenses 120 may be fabricated on a single substrate using the techniques disclosed herein.

While in the embodiment of FIGS. 1A-1D the Fresnel lens 120 comprises a circular structure, it will be appreciated that numerous other designs for the Fresnel lens 120 may be used that do not have generally circular shapes. Thus, it will be appreciated that the Fresnel lens 120 may be modified from what is shown in FIGS. 1A-1D to have any appropriate shape that uses diffraction to perform desired beam shaping for a received light field.

Typically, the Fresnel lens 120 will be designed to operate in a diffractive mode. However, it will be appreciated that, in some embodiments, it may be desirable to form Fresnel lenses 120 that operate in a reflective mode. In such embodiments, the substrate 110 may be formed of a material that reflects, as opposed to transmits, optical signals of the wavelength of interest. In other embodiments, one or more reflective layers may be provided on the substrate 110 that reflect an incident optical signal. These reflective layers may be positioned, for example, on the bottom surface 112 of the substrate 110 or on the top surface 114 of the substrate 110. FIG. 1E is a schematic side view of a portion of a light focusing element 100′ that includes a substrate 110 that includes a Fresnel lens 120 thereon. A reflective layer 130 is provided between the substrate 110 and the Fresnel lens 120 that allows the light focusing element 100′ to operate in a reflective mode.

As noted above, in some embodiments, the light focusing elements 100 and 100′ may be fabricated using semiconductor growth and/or processing technologies. By way of example, one or more epitaxial layers may be epitaxially grown or deposited on the substrate 110 via metal organic chemical vapor deposition, sputtering, laser deposition, plasma deposition or other semiconductor growth or deposition techniques. These layers may be selectively grown and/or non-selectively grown and then patterned using photolithography or other semiconductor patterning techniques to form the Fresnel lens 120 in or on the substrate 110. In other embodiments, the substrate 110 may simply be etched using photolithography techniques, laser micro or nanomachining or other patterning techniques to etch away portions of the top surface 114 of substrate 110 to form the Fresnel lens 120.

FIGS. 1F-1G illustrate a modified version 100′ of the light focusing element 100 of FIGS. 1A-1E. In particular, FIG. 1F is a schematic plan view of the light focusing element 100′ and FIG. 1G is a cross-sectional view of the light focusing element 100′ taken along the line 1G-1G of FIG. 1F.

It will be appreciated that the curved surfaces (e.g., the angled outer surfaces 124) that are included in the Fresnel lens 120 of the light focusing element 100 may be more difficult to manufacture using certain semiconductor growth and/or processing technologies. Accordingly, pursuant to further embodiments of the present invention, light focusing elements may be provided that omit such curved surfaces. Such embodiments may be referred to herein as “binary” Fresnel lenses.

For example, as shown in FIGS. 1F-1G, the light focusing element 100′ includes a binary Fresnel lens 120′. In particular, as shown in FIG. 1G, the light focusing element 100′ includes a substrate 110 that has a light focusing structure in the form of Fresnel lenses 120′ disposed on the top surface thereof. The substrate 110 may be identical to the substrate 100 of FIGS. 1A-1E and hence will not be described further herein.

As shown in FIGS. 1F and 1G, the Fresnel lens 120′ includes a plurality of Fresnel zones 122′. However, in contrast to the Fresnel zones 122 of the light focusing element 100, the Fresnel zones 122′ do not have angled outer surfaces, but instead are simply formed using a plurality of concentric rings. The Fresnel zones 122′ may become increasingly narrower the farther they are from the center of the Fresnel lens 120′, and the spacings between adjacent Fresnel zones 122′ may also decrease the farther they are from the center of the Fresnel lens 120′. This arrangement may act to focus light that is incident on the Fresnel lens 120′ to a smaller area light field. The light focusing may not be as effective as the light focusing that may be obtained with the Fresnel lens 120 of the light focusing element 100, but may still be sufficient for many applications, and may be more easily manufactured. The Fresnel zones 122′ may be formed from a single piece of material or from different materials. The Fresnel lens 120′ may be formed by any of the techniques, discussed above, that may be used to form the Fresnel lens 120, and the Fresnel lens 120′ will operate in the same manner as the Fresnel lens 120 to focus light into a smaller area light field. It will also be appreciated that the Fresnel lens 120′ may be used in place of the Fresnel lens 120 in the substrate 150 of FIG. 1D, and that the Fresnel lens 120′ may also be configured to operate in either a transmissive diffraction mode or a reflective diffraction mode.

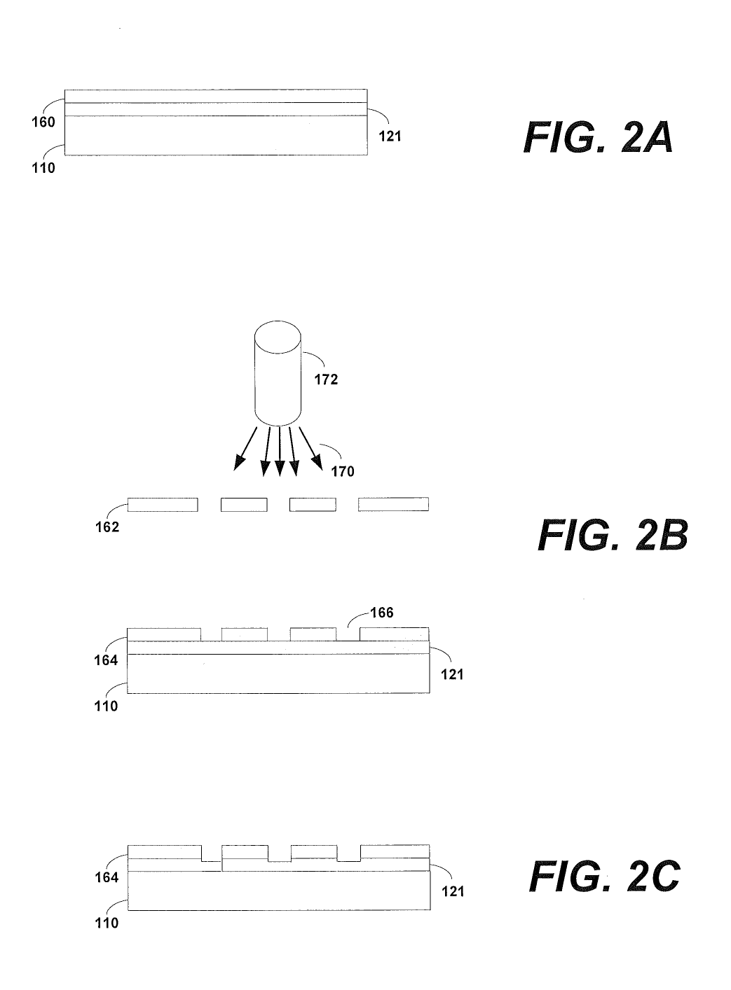

FIGS. 2A-2C illustrate processes according to embodiments of the present invention that may be used, for example to fabricate the substrate 150 of FIG. 1D. To simplify the drawings, FIGS. 2A-2C only illustrate a cross-section of a portion of one of the light focusing structures of FIG. 1D.

As shown in FIG. 2A, a photoresist layer 160 may be deposited onto a substrate 110 that includes a Fresnel lens formation layer 121 thereon. As shown in FIG. 2B, light 170 from a light source 172 is then used to transfer a geometric pattern from a photomask 162 onto the photoresist 160 to form a patterned photoresist 164. The patterned photoresist 164 includes a plurality of openings 166 that selectively expose portions of the Fresnel lens formation layer 121. Then, referring to FIG. 2C, standard semiconductor etching techniques including, for example, plasma etching, wet etching, dry etching, high energy ion beam etching, electron beam etching, deep reactive ion etching and the like may be used to pattern the Fresnel lens formation layer 121 into a desired shape such as, for example, into the shape of a Fresnel lens 120. Typically, a series of photolithography processes are performed to form, for example, the curved outer surfaces of each Fresnel zone 122. As photolithography and etching techniques are well known in the art, the example of FIG. 2 only illustrates the first of the etching steps. It will be appreciated, however, that a plurality of photolithography steps would typically be performed to fabricate the substrate 150 of FIG. 1D.

While the example embodiment described with respect to FIGS. 2A-2C includes a Fresnel lens formation layer 121 on the substrate 110, it will be appreciated that, in other embodiments, the Fresnel lens formation layer 121 may be omitted and the Fresnel lens 120 may be etched directly into the substrate 110. It will also be appreciated that the Fresnel lens formation layer 121 may comprise a multi-layer structure.

In other embodiments, laser micro-machining techniques may be used instead of photolithography to pattern the substrate 110 (or the substrate 110 including one or more epitaxial or other layers that are deposited or grown thereon) to form the plurality of Fresnel lenses 120 included on the substrate 150 of FIG. 1D. In still other embodiments, ion-beam etching may be used without the use of photolithography masks. In still other embodiments, two-photon polymerization growth processes may be used to form the Fresnel lenses 120. Pursuant to these two-photon polymerization processes, a gel such as a polymer gel or a silica gel may be deposited on the substrate 110. A laser may then be controlled to send photons through the gel which induce a chemical reaction that cross-links the gel to form a solid such as, for example, solid glass (in the case of a silica gel). The non-cross-linked gel may then be washed or drained away. The laser may be controlled to only cross-link portions of the gel that form structures having a desired shape from the gel on the substrate 110. In each case, the above-described processing techniques may be used to form a large number of Fresnel lens 120 on a single substrate which may subsequently be diced into individual light focusing elements. Thus, it will be appreciated that any of the above-described techniques may be used to mass produce light focusing elements at low cost.

While the embodiments discussed above with respect to FIGS. 1A-1E and FIGS. 2A-2C illustrate the formation of one or more Fresnel lenses 120 on a substrate 110/150, it will be appreciated that according to other embodiments of the present invention diffractive structures other than Fresnel lenses may be formed on or in the substrate 110/150. For example, instead of Fresnel lenses, diffractive structures can be fabricated on the substrate 110/150 such that specific optical intensity or field patterns (e.g., annular, dot matrix etc.) can be produced by incident light.

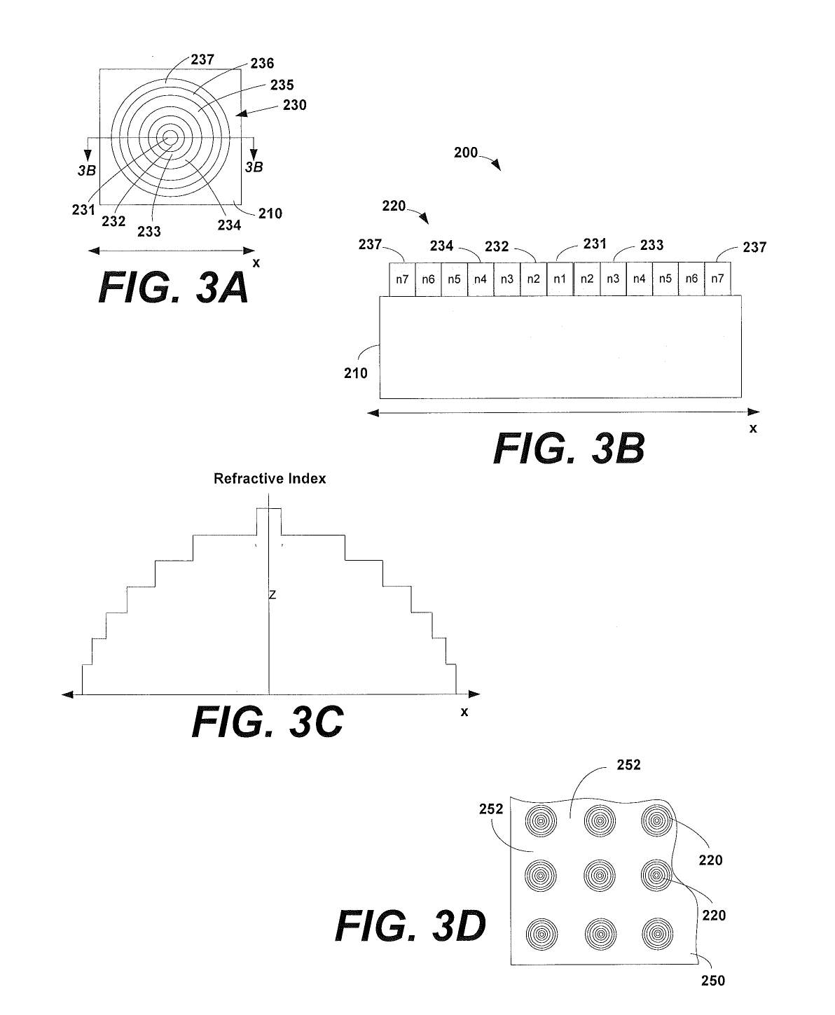

Pursuant to further embodiments of the present invention, graded index structures or lenses may be formed on a substrate using semiconductor processing or other mass-production techniques. FIGS. 3A-3D are various views illustrating one or more light focusing elements 200 according to embodiments of the present invention that are implemented using graded index structures. In particular, FIG. 3A is a schematic plan view of one of the light focusing elements 200. FIG. 3B is a cross-sectional view of the light focusing element 200 taken along the line 3B-3B of FIG. 3A. FIG. 3C is a schematic graph illustrating the refractive index of a graded index structure included in the light focusing element 200 of FIGS. 3A-3B, Finally, FIG. 3D is a schematic plan view of a substrate 250 that includes a plurality of the light focusing structures 200 fabricated thereon.

As shown in FIGS. 3A-3B, the light focusing element 200 comprises a plurality of concentric rings of material 230 (which are labeled individually as 231-237 in the figures) that are formed on a top surface of a substrate 210 to provide the graded index structure 220. Each of the concentric rings 230 may have a different refractive index “n” (e.g., n1, n2, n3, etc.). As shown in FIG. 3C, the refractive index of the materials used to form the concentric rings 230 increases the closer the concentric rings 230 are to the center of the graded index structure 220. The substrate 210 may comprise, for example, a semiconductor substrate such as a silicon substrate, a silicon carbide substrate, etc. or a non-semiconductor substrate such as, for example, a sapphire substrate, a silica substrate, etc. or a combination thereof such as a silicon-on-insulator substrate. The substrate 210 may be transparent at a particular wavelength or range of wavelengths.

The graded index structure 220 may be used to focus a large area light field into a smaller area light field. The graded index structure 220 may focus light that is incident in a direction that is generally normal to the top surface 214 of the substrate 210. Thus, the light that is focused by the graded index structure 220 passes through the substrate 210. The variation in the refractive index of the concentric rings of material 230 focuses the large area light field as the light field passes through the graded index structure 220 (or alternatively, disperses a small area light field that is passed through the graded index structure 220 in the opposite direction into a larger area light field).

The light focusing structure 200 of FIGS. 3A and 3B may be formed by using circular masks in a series of growth processes (e.g., an MOCVD growth process, a sputtering process, a laser deposition processes, plasma deposition processes, etc.) to selectively grow the concentric rings of material 230 that have different refractive indices. In other embodiments, the substrate 210 or a layer (not shown in the figures) that is deposited on the substrate 210 may be modified using material modification techniques to form the concentric rings of material 230 that have different refractive indices. For example, a layer of material may be deposited on the substrate 210 which has a diffractive index that changes in response to exposure to a laser. Masks may be used to selectively exposes concentric rings of this material to a laser beam such that the laser beam can modify each concentric ring of material to have a desired refractive index. Thus, it will be appreciated that the graded index structure 220 may be formed in a variety of different ways.

FIG. 3D is a schematic plan view of a portion of a substrate 250 that includes a plurality of graded index structures 220 disposed thereon. The substrate 250 may be identical to the substrate 210 that is described above, except that the substrate 250 may be much larger so that a large number of graded index structures 220 may be formed on a single substrate. The substrate 250 may include scribe lines 252 that run in rows and columns between the graded index structures 220. After the graded index structures 220 are formed on the substrate 250, the substrate 250 may be diced along the scribe lines 252 to create a plurality of individual light focusing elements 200. While FIG. 3D depicts a total of nine graded index structures 220 on the portion of the substrate 250 that is illustrated, it will be appreciated that very large numbers of graded index structures 220 may be fabricated on the substrate 250 using the techniques disclosed herein.

While in the embodiment of FIGS. 3A-3D the graded index structures 220 each comprise a circular structure, it will be appreciated that numerous other designs may be used, including far more complex structures that have desired beam shaping or beam forming properties. It will also be appreciated that the graded index structures 220 may be designed to operate in a reflective mode as well. It will further be appreciated that inverted graded index structures may be provided in which the refractive index is larger for the outer concentric rings of material 230 and smaller for the inner concentric rings of material 230.

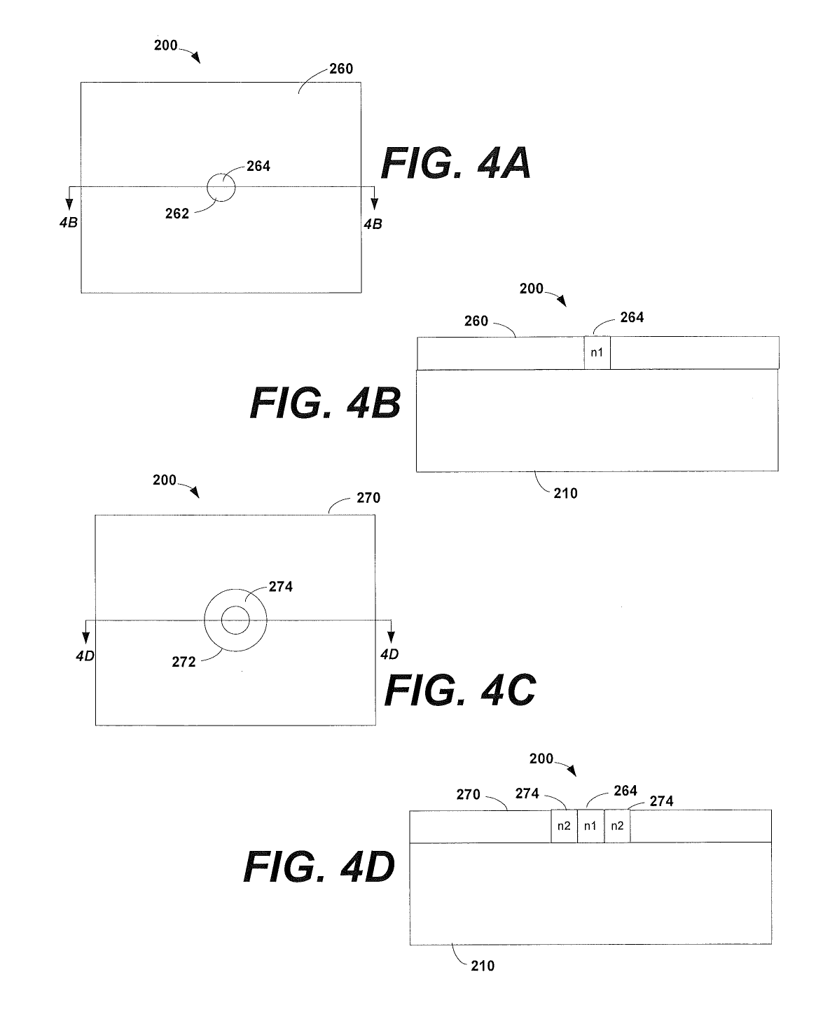

FIGS. 4A-4D illustrate an example method of fabricating the light focusing element 200 of FIGS. 3A-3B. In particular, FIGS. 4A and 4C are schematic plan views of the light focusing element 200, while FIGS. 4B and 4D are cross-sectional diagrams taken along the line 4B-4B of FIG. 4A and along the line 4D-4D of FIG. 4C, respectively.

Referring to FIGS. 4A and 4B, a first mask layer (not shown) may be deposited on the substrate 210 and may be patterned using, for example, conventional semiconductor processing photolithography techniques to create a first mask 260 that has a circular opening 262 that exposes the substrate 210. A first material layer (not shown) may then be deposited on the first mask 260 and in the first opening 262 in the first mask 260, and a planarizing technique such as a chemical-mechanical polishing technique may be used to remove all portions of the first material layer except for the portion 264 that is deposited in the first opening 262. The first material layer may have a first refractive index n1. A stripping or other conventional process may then be used to remove the first mask 260.

Referring to FIGS. 4C and 4D, a second mask layer (not shown) may be deposited on the substrate 210 and the remaining portion 264 of the first material layer. The second mask layer may be patterned using, for example, conventional semiconductor processing photolithography techniques to create a second mask 270 that has an annular opening 272 that exposes the substrate 210. A second material layer (not shown) may then be deposited on the second mask 270 and in the second annular opening 272 in the second mask 270, and a planarizing technique such as a chemical-mechanical polishing technique may be used to remove all portions of the second material layer except for the portion 274 that is deposited in the second annular opening 272. The second material layer may have a second refractive index n2 that is less than the refractive index n1. A stripping or other conventional process may then be used to remove the second mask 270.

The same process described above to form the concentric ring of material 274 may be used to form additional concentric rings of material that have larger diameters to complete the light focusing element 200 illustrated in FIGS. 3A and 3B.

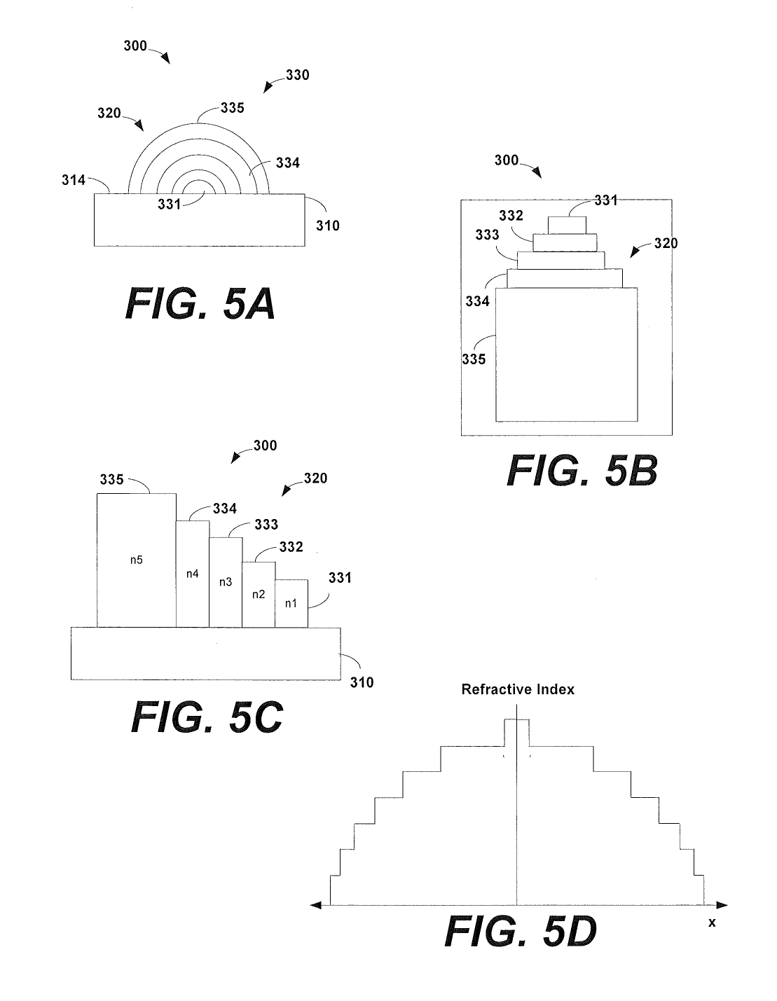

Pursuant to still further embodiments of the present invention, light focusing elements are provided that incorporate graded index waveguide technology. FIGS. 5A-5C illustrate one such light focusing element 300. In particular, FIG. 5A is schematic end view of the light focusing element 300, FIG. 5B is a schematic plan view of the light focusing element 300, and FIG. 5C is a schematic side view of the light focusing element 300. FIG. 5D is a graph that illustrates the refractive index of the various layers of the graded index waveguide included in the light focusing element 300.

As shown in FIGS. 5A-5C, the light focusing element 300 comprises a graded index waveguide 320 that is provided on a substrate 310. The graded index waveguide 320 comprises a series of half-cylinder structures 330 (which are labeled individually as 331-335 in the figures) that are longitudinally arranged on a top surface 314 of the substrate 310. The smallest of the structures 330 (structure 331) is on the right side of the substrate and the largest structure (structure 335) is on the left side of the substrate 310, and the structures 330 decrease in size as you move from the left to the right in the view of FIG. 5C. Each of the structures 331-335 may have a different refractive index “n” (see FIG. 5C) with the refractive index of the structures 331-335 increasing the smaller the size of the structure (i.e., n1>n2>n3>n4>n5). This is graphically illustrated in FIG. 5D. The substrate 310 may comprise, for example, a semiconductor substrate such as a silicon substrate, a silicon carbide substrate, etc. or a non-semiconductor substrate such as, for example, a sapphire substrate, a silica substrate, etc. or a combination thereof such as a silicon-on-insulator substrate.

The graded index waveguide 320 may be used to focus a large area light field into a smaller area light field. The variation in the refractive index of the materials used to form the structures 331-335 focuses the large area light field as the light field passes through the graded index waveguide 320 in a direction parallel to the top surface 314 of the substrate 310.

In some embodiments, the light focusing element 300 of FIGS. 5A-5C may be formed using semiconductor growth and photolithography techniques to grow and pattern the graded index waveguide 320 on the substrate 310. In other embodiments, the substrate 310 and/or a layer (not shown in the figures) that is deposited on the substrate 310 may be modified using material modification techniques (and possibly patterned as well using, for example, photolithography techniques) to form the structures 331-335 that have different indexes of refraction. For example, a layer of material may be deposited on the substrate 310 which has a refractive index that changes in response to exposure to a laser. Masks may be used to selectively expose portions of this material to a laser beam such that the laser beam can form the structures 331-335 having different refractive indexes. Thus, it will be appreciated that the graded index waveguide 320 may be formed in a variety of different ways.

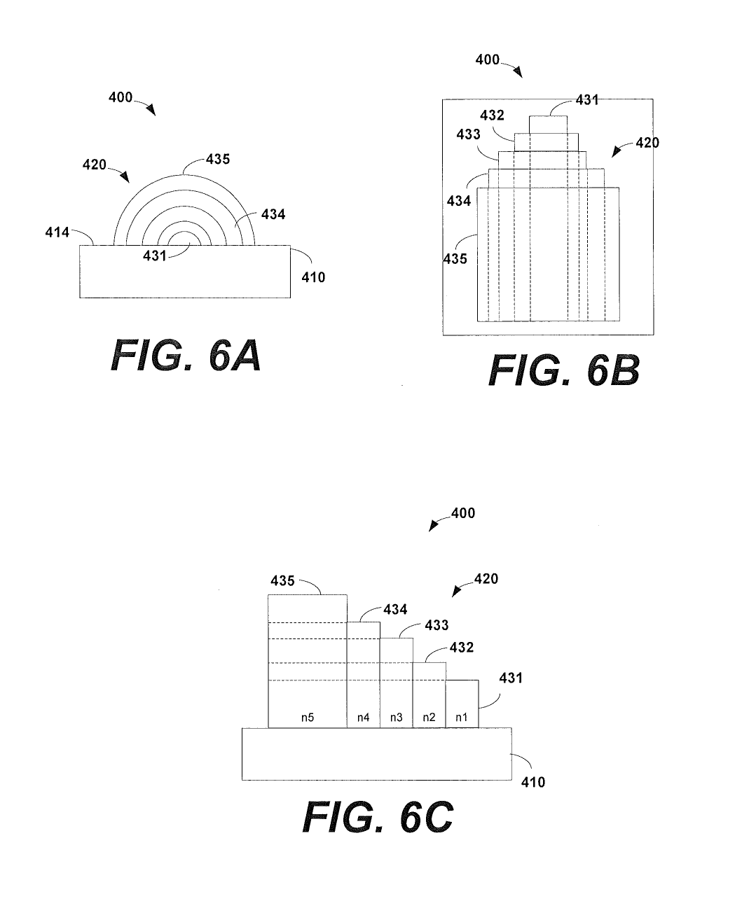

FIGS. 6A-6C illustrate a light focusing element 400 according to further embodiments of the present invention. In particular, FIG. 6A is schematic end view of the light focusing element 400, FIG. 6B is a schematic plan view of the light focusing element 400 and FIG. 6C is a schematic side view of the light focusing element 400.

As shown in FIGS. 6A-6C, the light focusing element 400 comprises a graded index lens 420 that is provided on a substrate 410. The graded index lens 420 comprises a series of structures 430 (which are labeled individually as 431-435 in the figures) that are formed on a top surface 414 of the substrate 410. The smallest of the structures 430 (structure 431) comprises a half-cylinder structure. The structure 432 is coaxially deposited on top of the structure 431, and has a half-annular shape. As shown in FIGS. 6B and 6C, the length of structure 432 is less than the length of structure 431 so that structure 431 extends farther to the right in the view of FIG. 6C than does the structure 432. Structures 433-435 are similarly deposited coaxially in order on structures 431 and 432 in the same fashion so that they each also have a half-annular shape, and the length of each structure 431-435 is reduced as compared to the length of the structure 431-435 that is directly underneath it. Each of the structures 431-435 may have a different refractive index “n,” with the refractive index of the structures 431-435 increasing the smaller the size of the structure (i.e., n1>n2>n3>n4>n5). The substrate 410 may comprise, for example, a semiconductor substrate such as a silicon substrate, a silicon carbide substrate, etc. or a non-semiconductor substrate such as, for example, a sapphire substrate, a silica substrate, etc. or a combination thereof such as a silicon-on-insulator substrate.

The graded index lens 420 may be used to focus a large area light field into a smaller area light field. The variation in the refractive index of the materials used to form the structures 431-435 focuses the large area light field as the light field passes through the graded index lens 420 in a direction parallel to a top surface of the substrate 410.

In some embodiments, the light focusing structure 400 of FIGS. 6A-6C may be formed using semiconductor growth and photolithography techniques to grow and pattern the graded index waveguide 420 on the substrate 410. In other embodiments, the substrate 410 and/or a layer (not shown in the figures) that is deposited on the substrate 410 may be modified using material modification techniques (and possibly patterned as well using, for example, photolithography techniques) to form the structures 431-435 that have different indexes of refraction. For example, a layer of material may be deposited on the substrate 410 which has a refractive index that changes in response to exposure to a laser. Masks may be used to selectively expose portions of this material to a laser beam such that the laser beam can form the structures 431-435 having different refractive indexes. Thus, it will be appreciated that the graded index lens 420 may be formed in a variety of different ways.

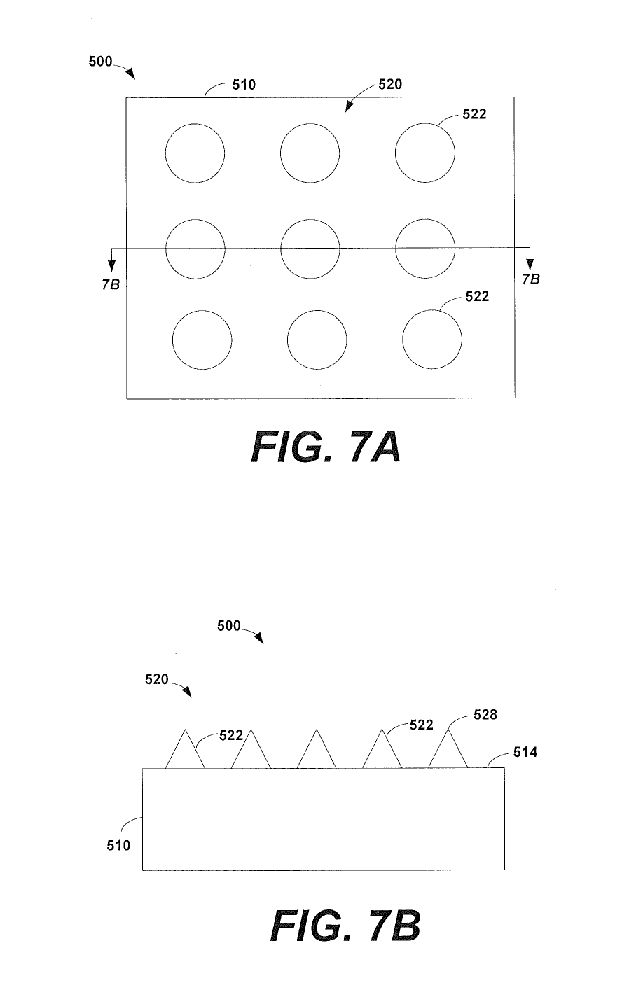

FIGS. 7A and 7B are, respectively, a plan view and a cross-sectional view (taken along line 7B-7B of FIG. 7A) of a light focusing element 500 according to still further embodiments of the present invention.

As shown in FIGS. 7A and 7B, the light focusing element 500 comprises an array 520 of inverted conical structures 522 that are formed on or in a top surface 514 of a substrate 510. The array 520 of inverted conical structures 522 may focus light that is incident on the array in a direction that is generally normal to the top surface 514 of the substrate 510. The substrate 510 may comprise, for example, a semiconductor substrate such as a silicon substrate, a silicon carbide substrate, etc. or a non-semiconductor substrate such as, for example, a sapphire substrate, a silica substrate, etc. or a combination thereof such as a silicon-on-insulator substrate. Multi-layered substrates 510 may be used, and the multiple layers may have the same refractive index or different refractive indexes. The substrate 510 may be transparent at a particular wavelength or range of wavelengths. While in the embodiment of FIGS. 7A and 7B the inverted conical structures 522 comprise structures having circular cross-sections, it will be appreciated that conical structures with other cross-sections (e.g., square cross-sections) may alternatively be used. It will likewise be appreciated that tapered structures that are non-conical may be used in place of the inverted conical structures 522 depicted in FIGS. 7A and 7B.

In some embodiments, the array 520 of inverted conical structures 522 may be formed by patterning the substrate 510 using photolithography or similar patterning processes. In other embodiments, the array 520 of inverted conical structures 522 may be formed by patterning the substrate 510 using laser-machining or micro-machining techniques, Any of the other techniques for forming light focusing elements that are disclosed herein may also be used. In some embodiments, the array may be formed by directly patterning the substrate 510, while in other embodiments, one or more layers or patterns may be grown or otherwise deposited on the substrate 510 and these layer(s) may then be patterned to form the array 520 of inverted conical structures 522.

Light such as an optical signal that is incident on the upper surface 528 of the array 520 passes through the array 520 and is focused into a smaller area light field. In some embodiments, at least part of the substrate 510 may be removed after the array 520 is fabricated using, for example, a grinding process, a chemical-mechanical polishing process and/or an etching step. In other embodiments, the substrate 510 may be left in place. While not depicted in the figures, it will be appreciated that a large plurality of arrays 520 may be formed on a single substrate 510, and this substrate 510 may then be diced to create a large number of individual light focusing elements 500.

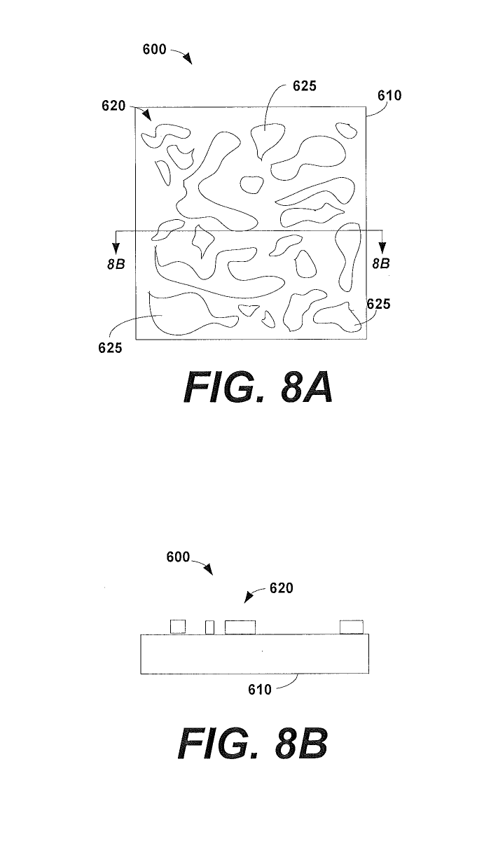

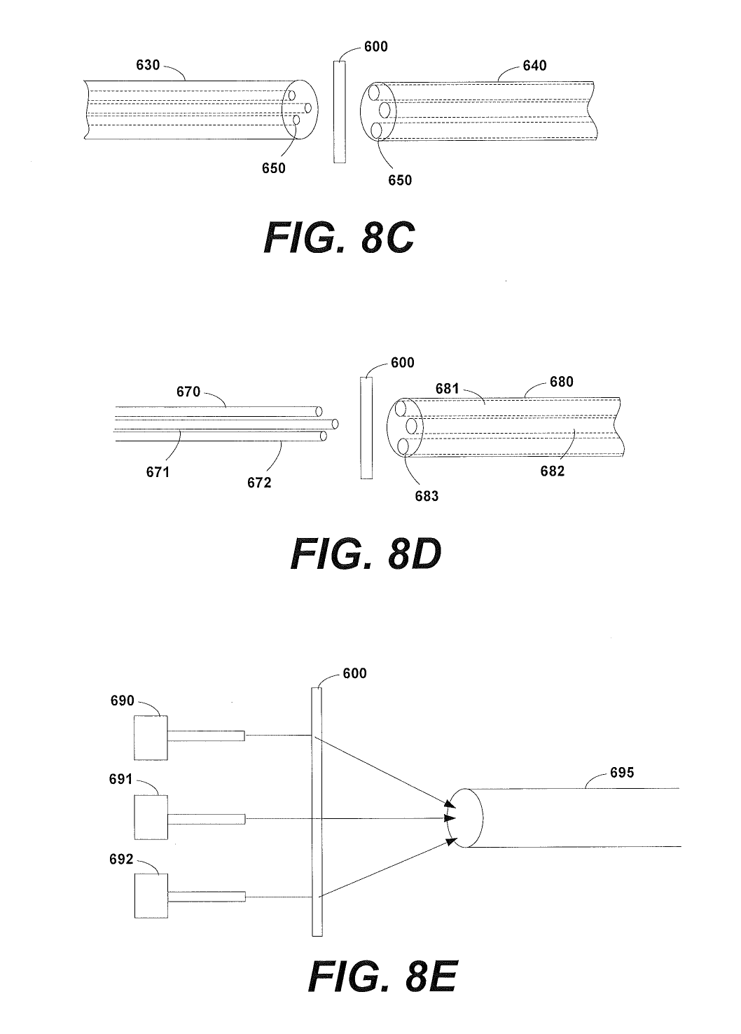

FIGS. 8A and 8B are, respectively, a plan view and a cross-sectional view (taken along line 8B-8B of FIG. 8A) of a light focusing element 600 according to yet another embodiment of the present invention. The light focusing element 600 uses a plurality of raised structures that appear to have an arbitrary pattern to focus light from one or more large area light fields into respective smaller area light fields.

As shown in FIGS. 8A and 8B, the light focusing element 600 comprises a substrate 610 that has a raised diffractive structure 620 formed on an upper surface thereof. The diffractive surface 620 may have what appears to be an arbitrary or random pattern, but in fact is a diffractive pattern that is designed to focus light in a specific manner. The pattern may include a number of “islands” of material that extend upwardly from the underlying substrate 610. These islands may have different shapes and sizes. The diffractive structure 620 may focus light that is incident on the array in a direction that is generally normal to the top surface 614 of the substrate 610. The substrate 610 may comprise, for example, a semiconductor substrate such as a silicon substrate, a silicon nitride substrate, etc. or a non-semiconductor substrate such as, for example, a sapphire substrate, a silica substrate, etc. or a combination thereof such as a silicon-on-insulator substrate. Multi-layered substrates 610 may be used, and the multiple layers may have the same refractive index or different refractive indexes. The substrate 610 may be transparent at a particular wavelength or range of wavelengths.

In some embodiments, the diffractive structure 620 may be formed by depositing one or more layers on the substrate 610 and then etching, machining or otherwise removing material to form the diffractive structure 620 that has a plurality of raised areas 625. In other embodiments, the diffractive structure 620 may be formed by simply etching, machining or otherwise removing material from the substrate 610 to form the diffractive structure 620 in an upper region of the substrate 610.

While the pattern of the diffractive structure 620 may appear arbitrary in some embodiments, it may be specifically designed to focus light or change the light field pattern in some predetermined and desirable ways. The pattern of the diffractive structure 620 may be determined using simulation techniques. For example, a particular application may have one or more optical sources that each have a generally known light field output. The goal may be to couple these one or more light fields into one or more other optical transmission or reception mediums that have different areas. Computer simulation programs are available that will start with (typically) a basic pattern and then iteratively vary the pattern in an effort to find specific patterns that do a good job of focusing the light field(s) from the optical source(s) so that they will efficiently couple into the one or more other optical transmission or reception mediums. These computer programs thus provide a technique for identifying diffractive patterns that will efficiently focus an input light field distribution into a desired output light field distribution. Once a diffractive pattern is identified using these computer programs, then any of the semiconductor growth and/or processing techniques and/or machining or other techniques that are discussed above may be used to form a diffractive structure 620 in or on a semiconductor substrate that has the desired diffractive pattern. It will be appreciated that the raised areas 625 may all have the same height above the bottom surface of the substrate 610, or may have different heights, and that the height of each raised area 625 need not be constant.

The light focusing element 600 may be particularly well-suited for applications where a plurality of first light fields need to be converted into a plurality of second light fields in a small space. By way of example, as shown in FIG. 8C, in some applications, it may be desirable to couple a first multi-core optical fiber cable 630 to a second multi-core optical fiber cable 640 where the size of the cores 650 in the two cables are not the same and/or are not aligned. In such applications, the diffractive structure 620 in the light focusing element 600 of FIGS. 8A and 8B may be designed to focus each core 650 of the first multi-core optical fiber cable 630 to a respective one of the cores 650 of the second multi-core optical fiber cable 640. Given the small size of the individual cores (e.g., 50-120 microns in diameter), it may be difficult to design a lens based coupler that can efficiently couple the cores 650 of the first cable 630 to the cores 650 of the second cable 640. The diffractive structure 620, however, may be used to focus, for example, all of the cores 650 in the first cable 630 to their respective cores 650 in the second cable 640 and hence may simplify the design of a coupler for coupling a first multi-core optical fiber cable 630 to a second multi-core optical fiber cable 640.

As another example, as is shown in FIG. 8D, in some applications, a plurality of waveguides 670-672 may be provided in a small space and it may be necessary to couple the light fields output by these respective waveguides into other structures such as the cores 681-683 of a multicore optical fiber 680 (or onto other structures such as other waveguides, optical fibers, etc.). Once again, the tight spacing may make it difficult to perform this coupling using traditional lens-based approaches. The light focusing element 600 may again be used to couple (and focus) the multiple light fields output by the waveguides 670-672 into their corresponding transmission media in the structures 681-683. It will be appreciated that the example of FIG. 8D is reversible in that the system could be designed so that the light travelled from the cores 681-683 of the multicore optical fiber 680 to the respective waveguides 670-672 as opposed to travelling in the opposite direction as described above. It will likewise be appreciated that the waveguides 670-672 could be replaced with a plurality of separate optical fibers and/or with a multicore optical fiber, and that the multicore optical fiber 680 could likewise be replaced with a plurality of waveguides and/or separate optical fibers in further embodiments of the present invention.

As yet another example, research is currently ongoing into transmitting multiple optical signals, each of which may be at the same wavelength, on a single multi-mode optical fiber using space-division multiplexing or Multiple-Input-Multiple-Output (MIMO) techniques. Pursuant to these techniques, each of the plurality of optical signals are launched onto the optical fiber in a different way so that the signals will have different spatial patterns that allow the signals to be distinguished from each other at a receiver. This technique is illustrated graphically in FIG. 8E, which shows a plurality of lasers 690-692 being used to launch optical signals that have the same wavelength onto a multimode optical fiber 695. In order to launch each of the optical signals on top the optical fiber 695 in a different manner, it may be necessary to point the lasers into the optical fiber 695 at different angles. It may be difficult, however, to line up the outputs of the lasers 690-692 in a desired fashion in front of the optical fiber 695 due to space constraints.

However, pursuant to embodiments of the present invention, a light focusing element 600 having a diffractive structure 620 may be placed between the outputs of the lasers 690-692 and the optical fiber 695 which may be used to focus the light fields output by the lasers 690-692 in a desired fashion so that the optical signal output by each of the respective lasers 690-692 is launched into the optical fiber at the desired angle. By using the light focusing element 600, it may be possible to position the lasers 690-692 at greater distances, and greater angles, from the optical fiber 695 while still launching the output of each of the lasers 690-692 into the optical fiber 695 at the proper angle to achieve spatial diversity, as is shown graphically in the schematic diagram of FIG. 8E. It will be appreciated that the example of FIG. 8E is reversible in that the system could be designed so that the light travelled from the optical fiber 695 to a plurality of other elements such as, for example, three optical receivers (which can be depicted graphically simply by changing the direction of the three arrows in FIG. 8E).

The light focusing elements according to embodiments of the present invention may be used in many different applications. In one example application, the light focusing elements may be mounted in optical connectors such as optical couplers and/or optical connector ports. In this application, the light focusing elements may be used, for example, to focus a light field from a larger optical fiber into a smaller optical fiber or to focus a light field from an optical fiber into a smaller light field that may be coupled into an optical waveguide or other optical transmission path. In such embodiments, the light focusing elements can be relatively large (e.g., 50 microns in diameter or more to fit, for example, adjacent to an end of a Multi-mode optical fiber) or can be much smaller (e.g., less than one micron in diameter). In other applications, the light focusing elements disclosed herein may be used for coupling multi-mode optical fibers to small area, high speed photodetectors, for coupling a multi-mode MPO connector to single-mode optical fibers and for coupling an array of multi-mode optical fibers (e.g., a multi-mode MPO connector) to a single multicore optical fiber or to a single-mode MPO connector within a very small form factor. As yet another example, the light focusing elements according to embodiments of the present invention may be used to couple the output of a vertical cavity surface emitting laser (“VCSEL”) onto a multi-mode optical fiber. The light focusing elements according to embodiments of the present invention may be able to more effectively couple the output of such VCSEL devices into desired areas of a multi-mode optical fiber which can increase the bandwidth that can be supported by the multi-mode optical fiber.

In some embodiments, the light focusing elements disclosed herein may be used as an optical mode field converter to compress a large area light field that is output from a multi-mode optical to a small area light field that is coupled onto a few-mode (including single-mode) optical fiber. Different arrangements and applications for such optical mode field converters are disclosed in U.S. Provisional Patent Application Ser. No. 61/651,771, filed on May 25, 2012, the entire content of which is incorporated herein by reference as if set forth in its entirety. The techniques disclosed herein may be used to form the various light focusing elements disclosed in U.S. Provisional Patent Application Ser. No. 61/651,771.

Pursuant to embodiments of the present invention, methods of fabricating tight focusing elements are provided that may be used to inexpensively mass-produce light focusing elements for fiber optic communications systems. In particular, hundreds or thousands of light focusing elements may be formed in or on a single substrate, and this substrate may then be diced to provide hundreds or thousands of individual light focusing elements. In addition, many of the light focusing elements according to embodiments of the present invention may be designed to receive light in a direction that is generally perpendicular to a top surface of the substrate (typically the substrate will be a disk-like element that has a large top surface, a large bottom surface, and side surface(s) that are much smaller than the top and bottom surfaces).

Embodiments of the present invention have been described above with reference to the accompanying drawings, in which embodiments of the invention are shown. This invention may, however, be embodied in many different forms and should not be construed as limited to the embodiments set forth above. Rather, these embodiments are provided so that this disclosure will be thorough and complete, and will fully convey the scope of the invention to those skilled in the art.

It will be understood that, although the terms first, second, etc. may be used above and in the claims that follow to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this disclosure and the relevant art and will not be interpreted in an idealized or overly formal sense unless expressly so defined herein.

All embodiments can be combined in any way and/or combination.

Many variations and modifications can be made to the preferred embodiments without substantially departing from the principles of the present invention. All such variations and modifications are intended to be included herein within the scope of the present invention, as set forth in the following claims.

That which is claimed is:

1. A method of fabricating light focusing elements for use in a fiber optic communications system, comprising:
forming a plurality of light focusing elements on or in a top surface of a substrate;
dicing the substrate to cingulate the light focusing elements.

2. The method of claim 1, wherein each light focusing element is configured to focus a large area light field that is incident in a direction that is generally normal to the top surface of the substrate into a smaller area light field.

3. The method of claim 2, wherein the light focusing elements comprise graded index structures, graded index waveguides or Fresnel lenses.

4. The method of claim 1, wherein the substrate comprises a transparent substrate for light at wavelengths in the range from about 830 nanometers to about 1360 nanometers.

5. The method of claim 1, further comprising at least partly removing a bottom surface of the substrate after forming the plurality of light focusing elements thereon.

6. The method of claim 1, wherein the light focusing elements are formed using photolithography processes to etch the top surface of the substrate or one or more layers that are deposited on the top surface of the substrate.

7. The method of claim 6, wherein the photolithography process includes:
depositing a photoresist on a top surface of the substrate;
using a photomask to transfer a geometric pattern onto the photoresist, the geometric pattern comprising a plurality of openings in the photoresist that expose the substrate; and
etching the exposed portions of the substrate using the photoresist as an etching mask.

8. The method of claim 1, wherein the light focusing elements are formed via laser micro-machining.

9. The method of claim 1, wherein the light focusing elements are formed via a two-photon polymerization process, which process includes the steps of:
depositing a gel on the substrate;
inducing a chemical reaction in selected portions of the gel to cross-link the selected portions of the gel; and
draining away non-cross-linked portions of the gel from the substrate.

10. The method of claim 1, wherein forming the plurality of light focusing elements on or in the top surface of the substrate comprises:
growing one or more material layers on the top surface of the substrate; and
patterning the grown material layers to form the plurality of light focusing elements.

11. The method of claim 1, wherein forming the plurality of light focusing elements on or in the top surface of the substrate comprises:
selectively growing the light focusing elements on the top surface of the substrate.

12. A wafer, comprising:
a substrate;
a plurality of light focusing elements on an upper surface of the substrate;
a plurality of scribe lines that separate the light focusing elements into rows and columns,
wherein each light focusing element is configured to focus a large area light field that is incident in a direction that is generally normal to the top surface of the substrate into a smaller area light field.

13. The wafer of claim 12, wherein the light focusing elements comprise graded index structures, graded index waveguides or Fresnel lenses.

14. The wafer of claim 12, wherein the substrate comprises a transparent substrate for light at wavelengths in the range from about 830 nanometers to about 1360 nanometers.

15. A method of fabricating light focusing elements for use in a fiber optic communications system, comprising:
forming a plurality of diffractive patterns on a substrate via at least one of lithography, dry etching, wet etching, laser micromachining or nano-machining to form a plurality of light focusing elements on the substrate;
dicing the substrate to singulate the light focusing elements.

16. The method of claim 15, wherein each light focusing element is configured to focus a large area light field that is incident in a direction that is generally normal to the top surface of the substrate into a smaller area light field.

17. The method of claim 15, wherein the light focusing elements are formed using photolithography processes to etch a top surface of the substrate or one or more layers that are deposited on the top surface of the substrate.

18. The method of claim 15, wherein the light focusing elements comprise graded index structures, graded index waveguides or Fresnel lenses.

19. The method of claim 2, wherein the light focusing elements comprise diffractive structures that include a plurality if different shaped and sized islands of material extending upwardly from the substrate.

20. The method of claim 2, wherein the light focusing elements comprise binary Fresnel lenses.
